(19) United States
(12) Patent Application Publication
(10) Pub. No.: US 2010/0322601 A1
(43) Pub. Date: Dec. 23, 2010

(54) ELECTRIC BROIL ELEMENT

(75) Inventor: Stacy SPRINGER, Murfreesboro, TN (US)

Correspondence Address: HARNESS, DICKEY & PIERCE, P.L.C., P.O. BOX 828, BLOOMFIELD HILLS, MI, 48303, US

(73) Assignee: EMERSON ELECTRIC CO., St. Louis, MO (US)

(21) Appl. No.: 12/818,990

(22) Filed: Jun. 18, 2010

Related U.S. Application Data
(60) Provisional application No. 61/218,129, filed on Jun. 18, 2009.

(51) Int. Cl. A21B 1/06

(52) U.S. Cl. 392/416

(57) ABSTRACT

A radiant energy electric broil element for a food heating unit, including a cross-sectional geometrical configuration having a planar flattened portion with a length greater than a planar length of any other planar portion, the planar flattened portion oriented in a direction of a food product to be heated to maximize a radiant energy produced by the broiler element toward the food product.

### CROSS-REFERENCE TO RELATED APPLICATIONS

This application claims the benefit of U.S. Provisional Application No. 61/218,129, filed on Jun. 18, 2009. The entire disclosure of the above application is incorporated herein by reference.

### FIELD

The present disclosure relates to electric heating elements for broilers in gas and electric ovens.

### BACKGROUND

Generally speaking, the broiler function in a gas oven is often inferior to that of the broiler function in an electric oven. It is difficult to direct the radiant energy generated by the broil function in a gas oven toward the food product, yielding poor cooking results both in heating coverage of the food product and the depth of heating penetration into the food product.

Historically, appliance manufacturers have either ignored the poor broiling performance of gas oven appliances or utilized a “booster” electric broil element intended to assist the gas broiler in the cooking function. Such “booster” electric broil elements, however, have demonstrated limited and inadequate cooking performance. First, amperage limitations of the circuit breaker utilized by the appliance cause the electric “booster” broil element to be limited in wattage. In addition, other design features of the “booster” electric broil element, such as element configuration and shape, have caused the radiant energy generated by the “booster” electric broil element to be insufficient for broiler function. For example, the “booster” electric broil elements comprise tubular sheathed heating elements like those used in electric oven applications. Such heating elements, in general, have a round cross-section. This round heating element projects radiant heat outward from the element in all directions, with only one point of the element focused toward the food product to be broiled. These factors contribute to the reduced overall efficiency and desirability of such “booster” electric broil elements.

Similarly, increases in energy efficiency and improvements to cooking performance are also sought by manufacturers of electric ovens, particularly for the electric heating elements and broil elements of those appliances.

### SUMMARY

This disclosure provides an electric heater element for a broiler (an electric broil element) for a gas or electric oven. The electric broil element has an optimized shape and cross-sectional configuration which increases the efficiency and improves the broiling capability of the element. As such, the broil element of the disclosure provides desirable cooking performance within space limitations and the amperage limitations of the circuit breakers of many appliances, including both gas and electric ovens.

The electric broil element of this disclosure reduces the overall heated length of the element while providing side-to-side coverage of the broiler/oven space and increasing the amount of radiant energy that is directed at the food product to be broiled.

The orientation of the broil element passes or outward wings, which span from side-to-side of the broiler/oven space, enables the broil element's overall heated length to be reduced while maintaining approximately the same coverage of the food product of an element of greater length.

Additionally, the broil element of the disclosure employs a cross-sectional geometrical configuration including a flattened portion that is oriented in the direction of the food product to be cooked. With such a configuration and orientation, an increased surface area of the broil element is facing the food product thereby increasing the amount of the broil element's radiant energy that is projected toward the food product during the broiling operation.

The improved heating efficiency of the broil element of the disclosure enables it to perform the broil function in desirable manner while keeping within the power limits of some appliances.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a front right perspective view of an electric broil element of the present disclosure;

FIG. 2 is a top plan view of the electric broil element of FIG. 1;

FIG. 3 is a right end elevational view of the electric broil element of FIG. 1;

FIG. 4 is a front elevational view of the electric broil element of FIG. 1;

FIG. 5 is a cross-sectional end elevational view of the electric broil element taken at section 5 of FIG. 2;

FIG. 6 is a cross-sectional end elevational view of the electric broil element taken at section 6 of FIG. 2;

FIG. 7 is a partial top plan view of the electric broil element taken at area 7 of FIG. 2;

FIG. 8 is a partial front elevational view of the electric broil element taken at area 8 of FIG. 4;

FIG. 9 is a top plan view of an electric broil element modified from the embodiment of FIG. 2 to eliminate the bend 44;

FIG. 10 is a top plan view of a 4 pass electric broil element;

FIG. 11 is a top plan view of a 4 pass electric broil element having additional side extending legs and pass support members;

FIG. 12 is a top plan view of a 6 pass electric broil element;

FIG. 13 is a front elevational view of the electric broil element of FIG. 12;

FIG. 14 is a graph showing a calculated time of 600 seconds to heat a meat food product from 100 to 176 degrees Fahrenheit;

FIG. 15 is a graph showing analytically derived temperatures reached at steady state conditions using a round broil element to heat a meat food item; and

FIG. 16 is a graph showing analytically derived temperatures reached at steady state conditions using a planar surface broil element with the planar surface directed at a meat food item.

### DETAILED DESCRIPTION

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

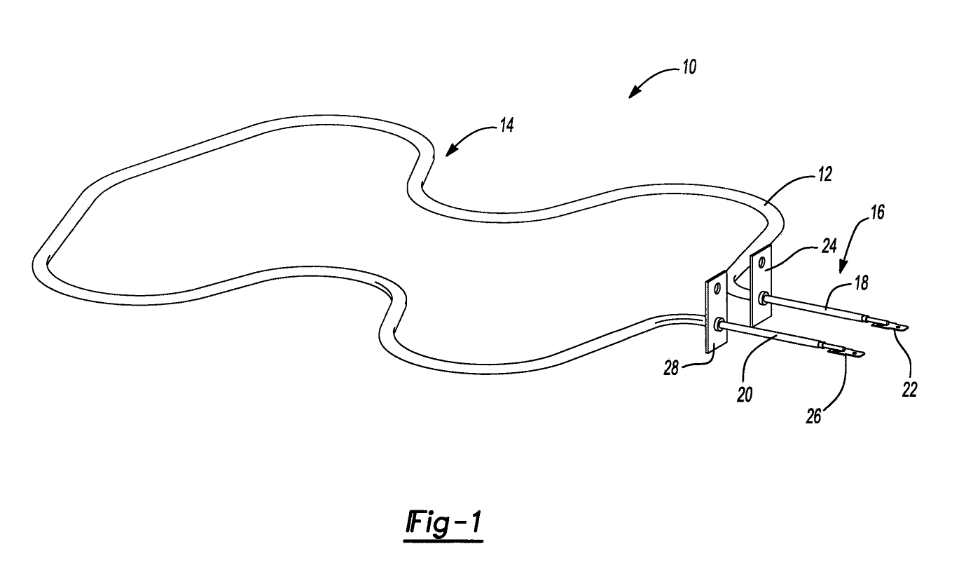

Referring to FIG. 1, a radiant energy electric broil element 10 includes an element body 12 having a radiant heating portion 14 and a connection portion 16. Connection portion 16 includes a first connecting end 18 and a substantially parallel second connecting end 20. First connecting end 18 further includes a first connection terminal 22 and a first body mounting device 24. First connection terminal 22 is provided for connecting element body 12 to a source of electrical power. First body mounting device 24 is provided to mechanically connect element body 12 to a device such as the broiler portion of an oven (not shown). Second connecting end 20 is similarly constructed as first connecting end 18 and further includes a second connection terminal 26 and a second body mounting device 28.

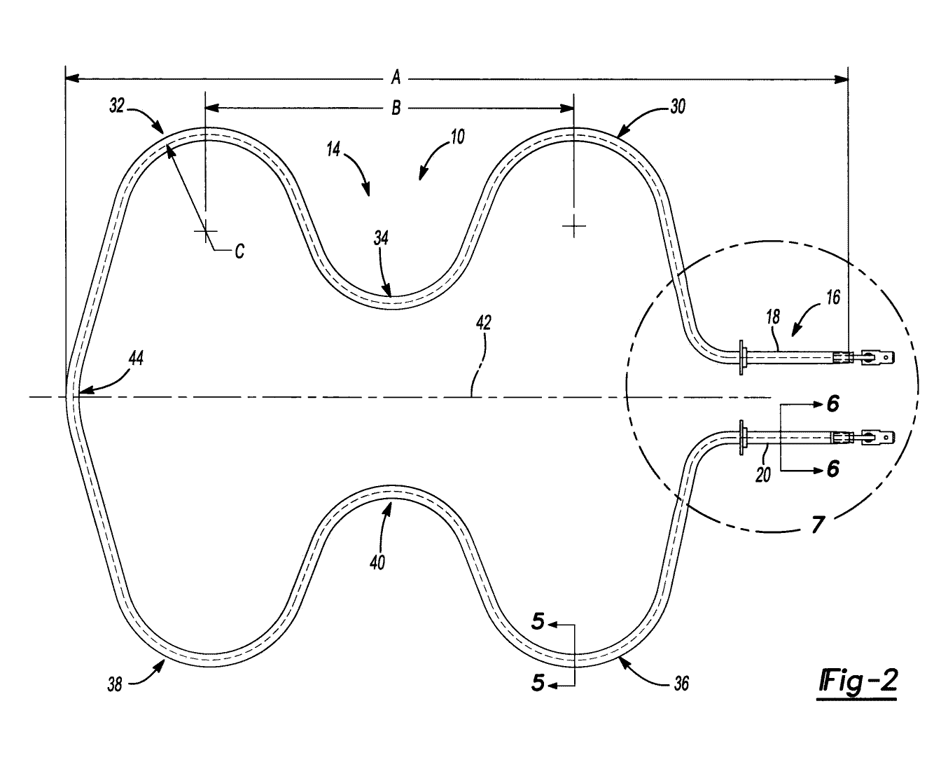

Referring to FIG. 2, radiant energy electric broil element 10 further includes first and second outward wings 30, 32 having a first inward connecting bend 34 positioned between first and second outward wings 30, 32. A third and a fourth outward wing 36, 38 are substantially mirror images of first and second outward wings 30, 32, respectively, and a second inward connecting bend 40 is substantially a mirror image configuration of first inward connecting bend 34. Each of the first, second, third, and fourth outward wings, as well as the first and second inward connecting bends 34, 40, are displaced with respect to a body longitudinal axis 42. According to several embodiments, element body 12 can further include a body end outward bend 44 which is substantially centrally positioned with respect to body longitudinal axis 42. Each of the first and second connecting ends 18, 20 are substantially equally spaced with respect to body longitudinal axis 42.

A body length “A” includes each of the connecting ends, the outward wings, and the body end outward bend. A wing spacing “B” is provided between each of first and second outward wings 30, 32 as well as between third and fourth outward wings 36, 38. The body length “A” and wing spacing “B” can vary at the discretion of the manufacturer to suit the geometry of the oven or broiler or other heating device which electric broil element 10 will be installed in. Each of the outward wings 30, 32, 36, 38 have a common wing radius “C”, however, this is not limiting to the present disclosure such that different wing radii can be used for each of the outward wings.

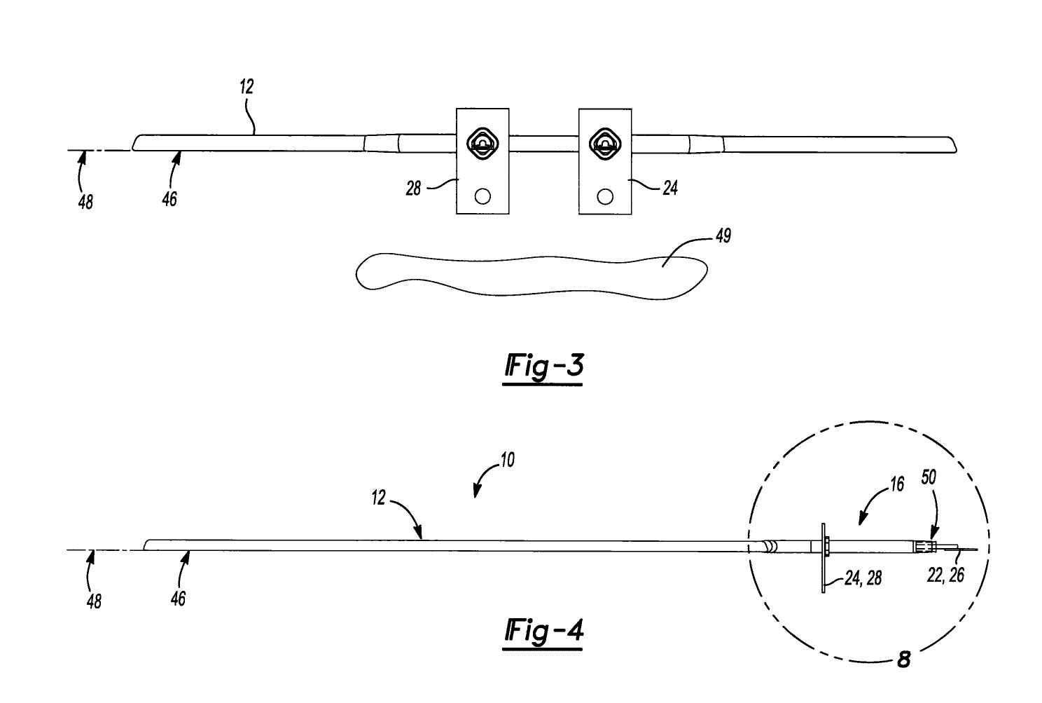

Referring to FIG. 3, element body 12 is provided with a body planar surface 46 which is oriented co-planar with a plane 48. Body planar surface 46 can therefore be entirely oriented toward a common direction and is commonly oriented entirely facing a food product 49 to be radiantly heated. Orienting body planar surface 46 toward the food product 49 maximizes a portion of a total amount of radiant energy produced by radiant energy electric broil element 10 that radiates toward and is therefore absorbed by the food product 49.

Referring to FIG. 4, the body planar surface 46 of radiant energy electric broil element 10 is continuous throughout the element body 12 and extends up to approximately the location of the first and second body mounting devices 24, 28. Thereafter, connection portion 16 can have a different geometric shape, such as a substantially circular shape, up to and including the position of a terminal assembly 50. Terminal assembly 50 includes each of the first and second connection terminals 22, 26 which will be described in further detail in reference to FIG. 8.

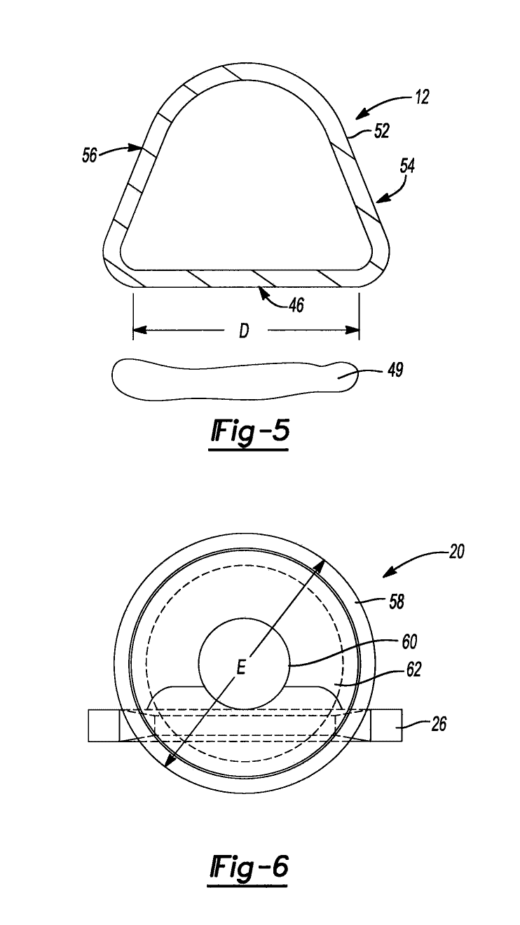

Referring to FIG. 5, element body 12 includes a body sheath 52 of a generally electrically nonconductive material which is selected to maximize a radiant energy output from element body 12. A planar surface length “D” of body planar surface 46 is greater than a corresponding length of either a second body surface 54 or a third body surface 56. According to several embodiments, element body 12 can generally form a substantially isosceles triangle shape with the lengths of second and third body surfaces 54, 56 minimized while maximizing the planar surface length “D” of body planar surface 46. By maximizing the planar surface length “D”, a maximum amount of electrical current energy carried by element body 12 is converted to radiant energy and directed toward the food product 49 to heat the food product 49 while minimizing the amount of radiant energy lost through second and third body surfaces 54, 56 to the ambient oven/broiler space. According to additional embodiments, element body 12 can further include other geometric shapes providing that body planar surface 46 is provided with each body shape and planar surface length “D” is maximized (meaning within the context of this disclosure maximized with respect to the surface area of the remaining perimeter surface(s) of the element body) to maximize the portion of radiant energy produced by element body 12 directed toward the food product 49.

Referring to FIG. 6, each of the first and second connecting ends 18, 20 are similarly constructed; therefore, the following description with respect to second connecting end 20 applies equally to first connecting end 18. Second connecting end 20 includes an insert receiving portion 58 having a receiving portion diameter “E”. According to several embodiments, receiving portion diameter “E” can be equal to a total or maximum span width of element body 12. A connector member 60 is centrally disposed through insert receiving portion 58 which is fixedly connected to the second connection terminal 26. An insert 62 fixedly receives connector member 60 at a free end of connection portion 16.

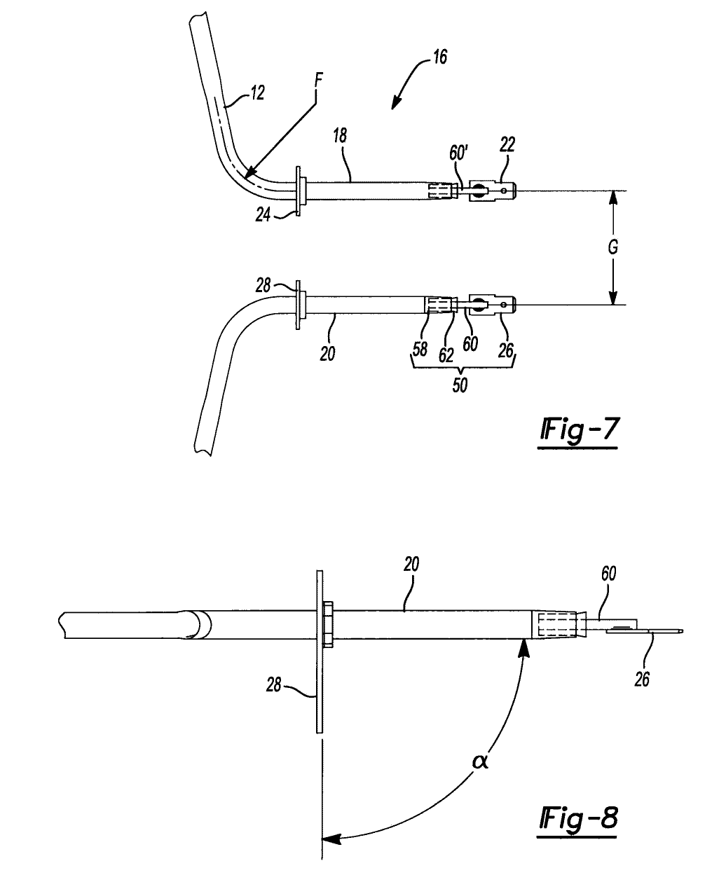

Referring to FIG. 7, element body 12 can be bent to an element body minimum bend radius “F” to transition from element body 12 to connection portion 16. A terminal spacing dimension “G” is provided between centerline axes of first and second connection terminals 22, 26. Each of the first and second connecting ends 18, 20 have similar connection fittings to join the first and second connection terminals 22, 26; therefore, the following discussion of second connecting end 20 is applicable equally to first connecting end 18. Insert receiving portion 58 slidably receives an insert 62 which has connector member 60 substantially centrally disposed therein. Connector member 60 is fixedly connected to second connection terminal 26 (i.e., by soldering, splicing, or the like). First and second body mount devices 24, 28 are provided at opposite ends of first and second connecting ends 18, 20 with respect to the first and second connection terminals 22, 26. This provides a degree of freedom of motion for making the electrical connections at first and second connection terminals 22, 26.

Referring to FIG. 8, each of the first and second body mounting devices 24, 28 (only second connection terminal 26 is clearly visible in this view) can be oriented at an angle α which according to several embodiments is approximately 90° with respect to the first or second connecting ends 18, 20 (only second connecting end 20 is clearly visible in this view). Angle α can also be greater than or less than 90° at the discretion of the manufacturer.

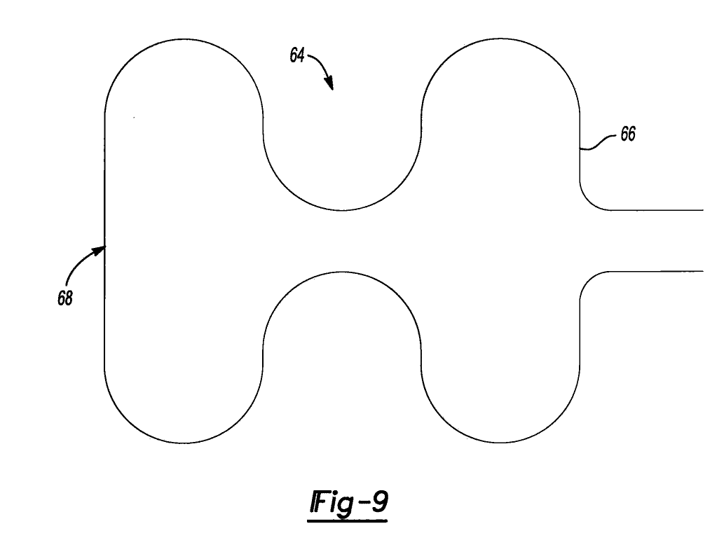

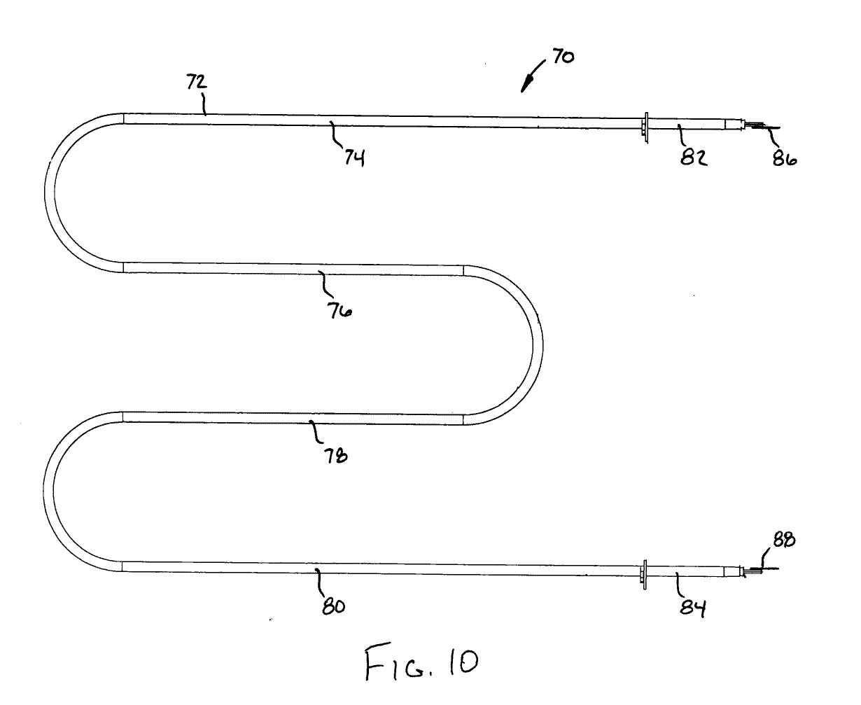

Referring to FIG. 9, according to additional embodiments of the present disclosure, an electric broil element 64 has a similar shape to electric broil element 10 with a difference being that a straight body end 68 is provided. With further reference to FIG. 2, straight body end 68 eliminates body end outward bend 44. Element body 66 is otherwise similarly geometrically shaped as element body 12, having a body planar surface similar to body planar surface 46 which is directed toward an item to be heated.

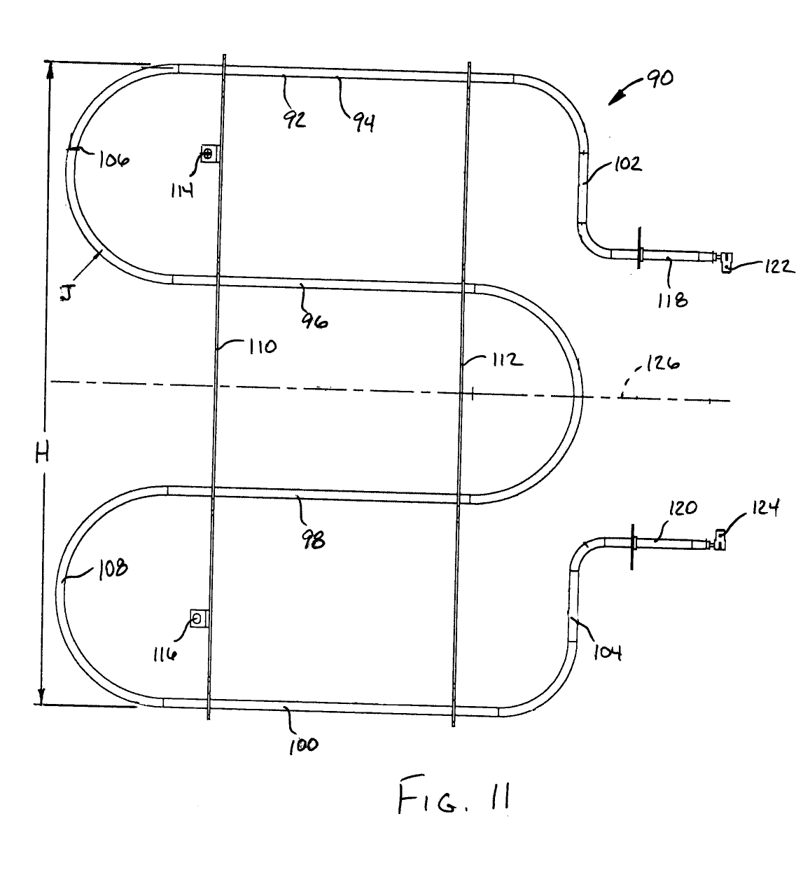

Referring to FIG. 10, an electric broil element 70 has a planar surface containing body 72 including first, second, third and fourth passes 74, 76, 78, 80. First pass 74 is aligned substantially co-axial with a first connecting end 82 and fourth pass 80 is aligned substantially co-axial with a second connecting end 84. First and second connecting terminals 86, 88 have flat surfaces oriented vertically (toward and away from the viewer) as viewed in FIG. 10.

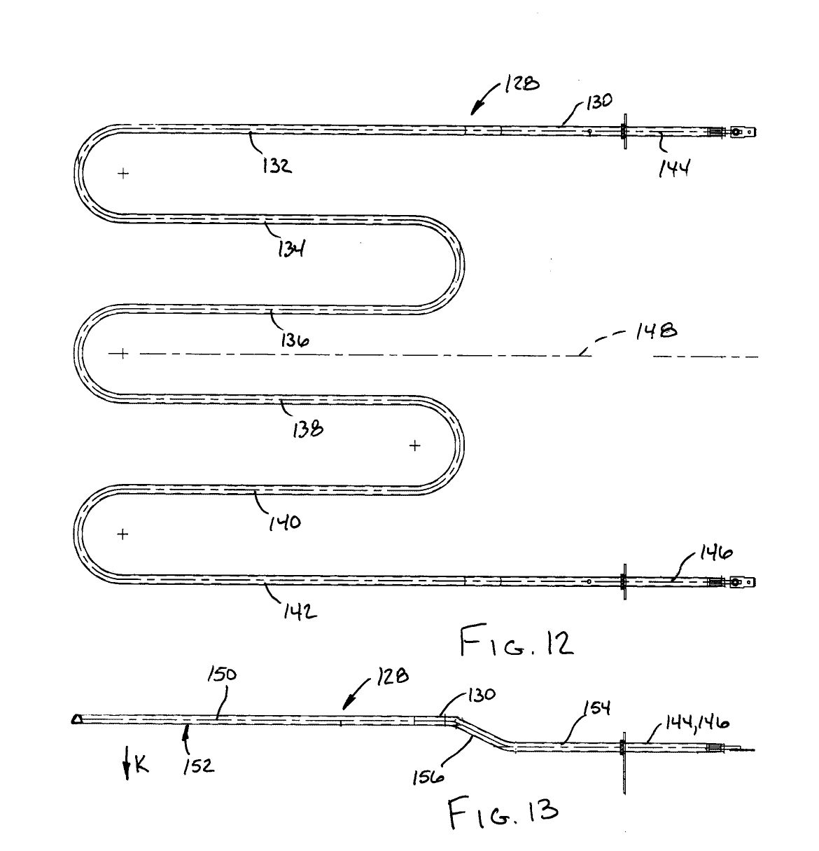

Referring to FIG. 11 and again to FIG. 10, an electric broil element 90 has a planar surface containing body 92 including first, second, third and fourth passes 94, 96, 98, 100. Electric broil element 90 is modified from electric broil element 70 in several respects. First and second side extending legs 102, 104 connected to first and fourth passes 94, 100 respectively allow a total width “H” of electric broil element 90 to be increased while also permitting a bend radius “J” of both a first and a second loop end 106, 108 to be increased with respect to electric broil element 70. To provide additional support for electric broil element 90, first and second support members 110, 112 are positioned substantially perpendicular to the first, second, third and fourth passes 94, 96, 98, 100 and provide direct connection and support to the passes. First and second connection fittings 114, 116 can also be fixedly connected to first support member 110 to provide additional support points for electric broil element 90, when connected for example to the inner, upper wall of an oven/broiler (not shown). First and second connecting ends 118, 120 are connected to first and second side extending legs 102, 104 and are oriented substantially parallel to first, second, third and fourth passes 94, 96, 98, 100. First and second connecting terminals 122, 124 have flat surfaces oriented horizontally as viewed in FIG. 10, and are directed inwardly toward an electric broiler element longitudinal axis 126.

Referring to FIG. 12 and again to FIG. 10, an electric broil element 128 has a planar surface containing body 130 modified from electric broil element 70 in several respects including use of first, second, third, fourth, fifth and sixth passes 132, 134, 136, 138, 140 and 142. First pass 132 is aligned substantially co-axial with a first connecting end 144 and sixth pass 142 is aligned substantially co-axial with a second connecting end 146. Each of the first, second, third, fourth, fifth and sixth passes 132, 134, 136, 138, 140, 142 and both the first and second connecting ends 144, 146 are aligned in parallel with an electric broiler element longitudinal axis 148.

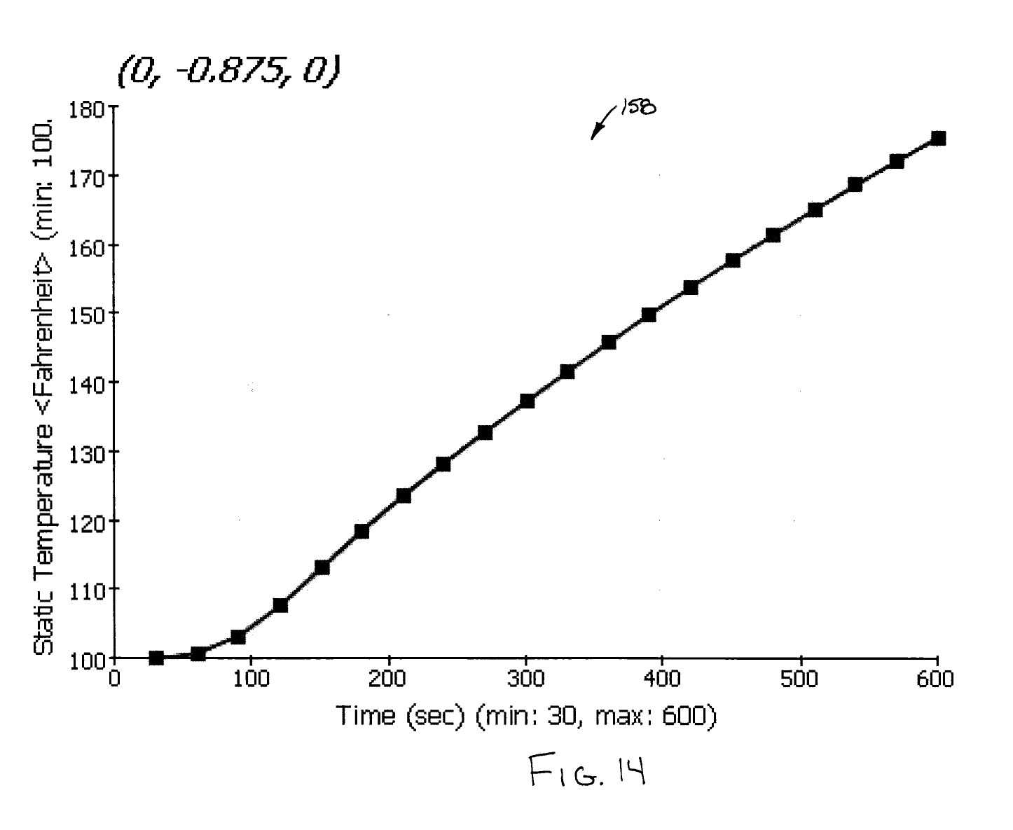

Referring to FIG. 13, planar surface containing body 130 is further modified to include an elevated portion 150 having a body planar surface 152 facing in a downward direction “K” as viewed in FIG. 13 which is oriented toward a food product (not shown) to be heated. Elevated portion 150 is displaced from a body portion 154 by an upwardly angled portion 156. Body portion provides two legs which are co-axially aligned with first and second connecting ends 144, 146.

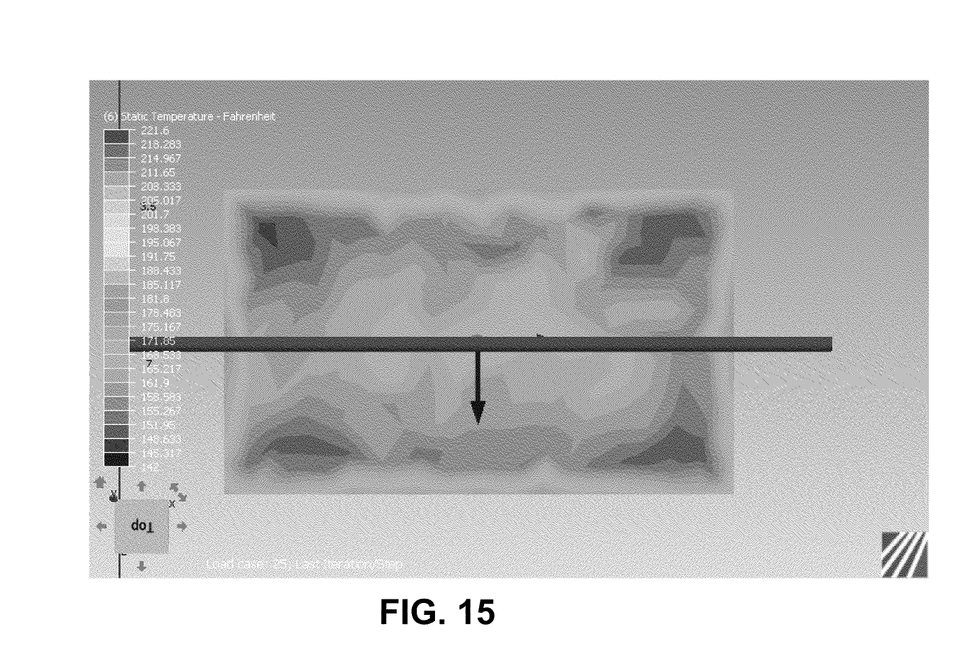

Referring to FIG. 14, a graph 158 identifies a calculated time of 600 seconds (10 minutes) for a meat food product to reach a temperature of approximately 176° F. from a starting temperature of 100° F. Graph 158 depicts results using a radiant energy broiler element of the present disclosure having a body planar surface directed toward the food product and a geometry as shown in FIG. 2. Meat food products heated by radiant energy from a planar surface broiler element of the present disclosure show an increased temperature per comparable unit of time compared to meat food products heated using a round broiler element known in the art.

Referring to FIG. 15, a round broiler element is modeled adjacent to a meat food item model and a temperature chart showing steady state temperatures of the meat food product of approximately 171° F. are reached when the model achieved a balanced steady state condition.

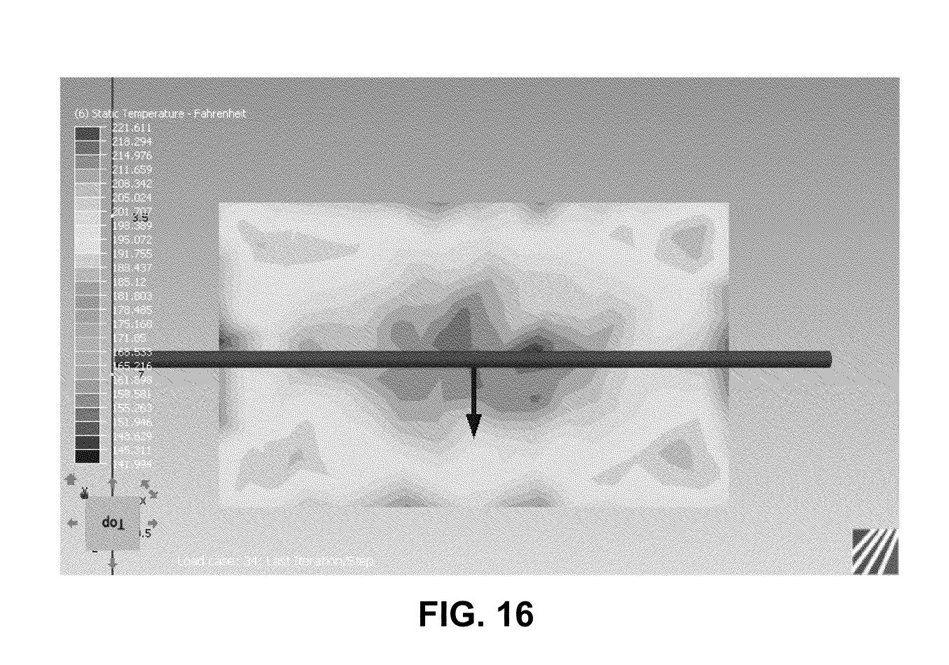

Referring to FIG. 16 and again to FIG. 15, a planar surface broiler element of the present disclosure is modeled and positioned adjacent to a meat food item model at the same distance and at the same starting conditions as the model used to create FIG. 15. A temperature chart showing steady state temperatures of the meat food product of approximately 221° F. is reached when the analytical model achieved a balanced steady state condition. Radiant energy from the planar surface broiler element is therefore demonstrated to heat the meat food product approximately 50° F. higher than the round broiler element, demonstrating the planar surface broiler element of the present disclosure directs a greater portion of the total energy generated by the broiler element into the meat food product to achieve a greater cooking efficiency.

Electric broil elements of the present disclosure offer several advantages. By maximizing a length of a body planar surface and orienting the body planar surface toward the food item to be heated, operation of electric broil elements of the present disclosure maximize the radiant heat energy directed toward the food product. Common electric broil elements are substantially circular in cross-section or have limited surface area directed toward the food item to be heated. Electric broil elements of the present disclosure maximize the radiant energy directed toward the food element by providing a maximum heated surface area facing the food product. The body planar surfaces, such as body planar surface 46 of the present disclosure, can also have slight curvature such as a concave curvature at the discretion of the manufacturer. Surface area detail of the body planar surfaces of the present disclosure can also be further modified by providing a rough surface finish, ridges, or similar geometries which increase the total surface area directed toward the food product. The term “electric broil element” as referred to herein also broadly applies to any electrical heating element such as those used in toaster ovens, toasters, heating elements for microwave ovens, and similar heating elements wherein the geometry of the body planar surface as described herein can be oriented toward an item to be heated.

A heating efficiency of a broil element of the present disclosure enables it to perform the broil function in a desirable manner while keeping within the power limits of some appliances. A body length of the broil element is selected to fit within a space envelope of an oven/broiler of common cooking appliances, such the broil element can be used as a supplemental heating element for gas ovens having a gas broiler, as the primary broil element of either a gas or electric oven, as the heating element of a toaster or toaster oven, or as the primary heating element of an electric oven.

The foregoing has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. An electric broil radiant heating element comprising a cross-sectional geometrical configuration including a flattened portion that is oriented in a direction of a food product to be heated maximizing transfer of a radiant energy produced by the heating element toward the food product.

2. The electric broil radiant heating element of claim 1 positioned in a gas oven.

3. The electric broil radiant heating element of claim 1 positioned in an electric oven.

4. The electric broil radiant heating element of claim 1, further comprising first and second broil element outward wings extending away from a body longitudinal axis and third and fourth broil element outward wings oppositely extending away from the body longitudinal axis with respect to the first and second outward wings.

5. The electric broil radiant heating element of claim 1, further comprising first and second broil element outward wings extending away from a body longitudinal axis and separated by an oppositely directed first inward connecting bend, and third and fourth broil element outward wings oppositely extending away from the body longitudinal axis with respect to the first and second outward wings and separated by an oppositely directed second inward connecting bend.

6. A radiant energy electric broil element for a food heating unit, comprising a cross-sectional geometrical configuration having a planar flattened portion with a length greater than a planar length of any other planar portion, the planar flattened portion oriented in a direction of a food product to be heated to direct and maximize radiant energy produced by the broil element toward the food product.

7. The radiant energy electric broil element of claim 6, positioned in a gas oven such that the electric heating element supplements a gas broiler.

8. The radiant energy electric broil element of claim 6, defining a primary broil element of an electric oven.

9. The radiant energy electric broil element of claim 6, positioned in an electric oven and defining a primary cooking element.

10. The radiant energy electric broil element of claim 6, further comprising oppositely positioned broil element outward wings oriented sinusoidally and from front to back within an oven.

11. The radiant energy electric broil element of claim 6, wherein the flattened portion is parallel with respect to a reference plane.

12. The radiant energy electric broil element of claim 6, further including a second portion defining a curve.

13. The radiant energy electric broil element of claim 6, wherein the flattened planar portion and a second portion together define a substantially triangular cross sectional shape.

14. In an oven having a broiler/oven space, a radiant energy electric broil element comprising a cross-sectional geometry having a flattened planar portion that is oriented toward a food product to be radiantly heated that passes the space from side-to-side in a sinusoidal pattern defining outward wings within the broiler/oven space, a length of the planar portion maximized with respect to a length of a remaining perimeter of the electric broil element to maximize a radiant energy produced by the broil element toward the food product.

15. The radiant energy electric broil element of claim 14, further including a second portion wherein the flattened planar portion and the second portion together define a substantially triangular shape.

16. The radiant energy electric broil element of claim 14, further including second and third body surfaces, wherein the planar flattened portion has a length greater than a length of either of the second or third body surfaces.
